(19) United States
(12) Patent Application Publication
(10) Pub. No.: US 2008/0161981 A1
(43) Pub. Date: Jul. 3, 2008

(54) INTERFACE EMULATING THE STARTING OF A VEHICLE HAVING AN ELECTRONIC STARTING SYSTEM

(76) Inventors: Martin Tessier, Mascouche (CA); Patrick Noel, Ste-Marthe-Sur-Le-Lac (CA); Jean-Pierre Aubertin, Laval (CA); Cristinel Zaharia, Montreal (CA); Duc Minh Cong Nguyen, Montreal (CA); Jacques Fortin, Montreal (CA)

Correspondence Address: GOUDREAU GAGE DUBUC, 2000 MCGILL COLLEGE, SUITE 2200, MONTREAL, QC, H3A 3H3, omitted

(21) Appl. No.: 11/957,887

(22) Filed: Dec. 17, 2007

Related U.S. Application Data
(60) Provisional application No. 60/874,944, filed on Dec. 15, 2006.

(30) Foreign Application Priority Data
Dec. 15, 2006 (CA) 2,571,594

(51) Int. Cl. G06F 19/00

(52) U.S. Cl. 701/2

(57) ABSTRACT

An interface for remotely starting a vehicle equipped with an electronic starting system employing an advanced key system, such as an electronic barrel and key combination or a pushbutton. In order to recreate the vehicle's starting sequence, upon actuation of a remote control device, the interface emulates electronic signals typically transmitted to the vehicle by the electronic starting system in order to start the vehicle.

### CROSS REFERENCE TO RELATED APPLICATIONS

This application claims priority on U.S. Provisional Application No. 60/874,944, filed on Dec. 15, 2006 and which is herein incorporated by reference in its entirety.

### FIELD OF THE INVENTION

The present invention relates to an interface for remotely starting a vehicle. In particular, the interface emulates electronic signals for starting or stopping the vehicle.

### BACKGROUND OF THE INVENTION

Before the event of some recent automotive technologies, in order to start the engine of a vehicle, users would typically insert a metal key into the vehicle's barrel, thus closing an electrical connection that generates an electronic message sent to the vehicle's starter computer. New vehicles on the market today no longer use a mechanical system to start the engine as they typically are equipped with electronic starting systems employing advanced key systems such as keyless fobs, smart cards, pushbuttons and the like. In this case, the signal sent to the starter computer is not generated by the teeth of the key fitting into a lock but rather by a simple dashboard switch. One drawback of these new technologies however is that they restrain the installation of remote starters currently known in the art in vehicles equipped with these technologies, thus preventing them from being started remotely. For example, some keyless fobs have exhibited interference with nearby radio waves and frequencies, such as those of conventional remote starters. In other cases, the products available on the market today are completely incompatible with these innovations.

What is therefore needed, and an object of the present invention, is a system for remotely starting a vehicle having an electronic starting system.

### SUMMARY OF THE INVENTION

More specifically, in accordance with the present invention, there is provided a system for emulating the remote starting and stopping of a vehicle, the system comprising: an electronic starting system comprising an ignition switch; an interface installed on the vehicle; a control unit for commanding the interface; and a remote control device for transmitting to the control unit start or stop commands to be executed in the vehicle upon actuation by a user, wherein upon receiving one of the start or stop command, the control unit instructs the interface to emulate electronic signals of the electronic starting system for starting or stopping the vehicle.

In accordance with the present invention, there is also provided a method for starting and stopping a vehicle remotely using a system comprising a remote control device, a control unit and an interface, the method comprising the steps of: actuating the remote control device to transmit to the control unit start or stop commands to be executed in the vehicle; receiving one of the start or stop command at the control unit; instructing the interface to emulate electronic signals for starting or stopping the vehicle.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic diagram of a system for emulating starting of a vehicle in accordance with an illustrative embodiment of the present invention;

FIG. 2 is a schematic diagram of an interface of a system for emulating starting of a vehicle in accordance with an illustrative embodiment of the present invention;

FIG. 3 is a flowchart of a starting and stopping sequence of the system in accordance with an illustrative embodiment of the present invention;

FIG. 4 is a schematic diagram of a system for emulating starting of a vehicle in accordance with an alternative illustrative embodiment of the present invention; and

FIG. 5 is a schematic diagram of a system for emulating starting of a vehicle in accordance with another alternative illustrative embodiment of the present invention.

### DESCRIPTION OF ILLUSTRATIVE EMBODIMENTS

The present invention is illustrated in further details by the following non-limiting examples.

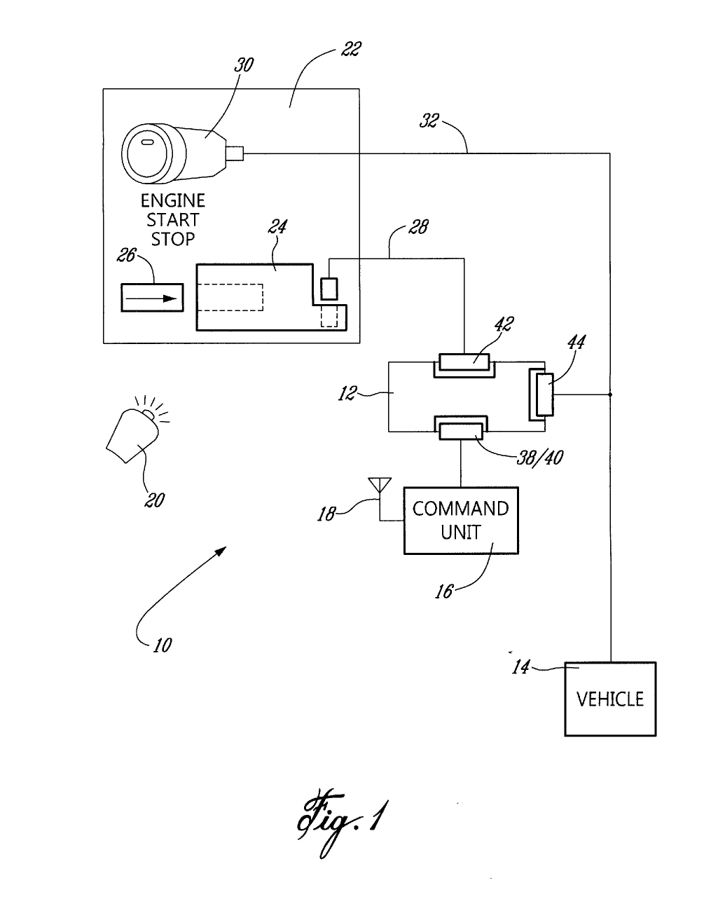

Referring now to FIG. 1, a system for starting a vehicle remotely, generally referred to using the reference numeral 10, will now be described. The system 10 comprises an interface 12 for remotely starting a vehicle 14 and a command unit 16 connected to the interface 12 for receiving via an antenna 18 commands (e.g. start or stop commands) to be executed in the vehicle 14 upon actuation of a remove control as in 20 by the user. The vehicle 14 is illustratively equipped with an electronic starting system 22 comprising an electronic barrel 24, which is an electronic module that enables a user to start (or stop) the vehicle 14 by transmitting the start (or stop) commands upon introducing therein a device 26. The device 26 uses an advanced key system (e.g. a smart key or smart card), which switches the vehicle's ignition on automatically without requiring the user to insert a conventional mechanical car key in the ignition. The electronic barrel 24 is illustratively connected to the interface 12 via an interface harness 28. The electronic starting system 22 could further comprise a push button as in 30 connected to the vehicle 14 via the vehicle's original wiring harness 32 to further authorize starting of the vehicle 14. Illustratively, only the pushbutton 30 may be present in the vehicle, in which case the pushbutton 30 would be the device transmitting commands to the vehicle 14.

Still referring to FIG. 1, and as will be described further herein below, the interface harness 28 connects the electronic barrel 24 to the interface 12 in order for the latter to emulate analog and/or digital signals (depending on the type of vehicle and the automobile manufacturer's ignition design), which recreate the starting sequence of the vehicle 14. These emulated signals are reproduced on the original wiring harness 32 of the vehicle 14, which connects the electronic barrel 24 and/or the pushbutton 30 (if any) to the vehicle 14 and transmits user-initiated commands. As known in the art, the harness 32 is illustratively made of a plurality of materials such as copper, aluminium, and optical fibers having different radio frequencies.

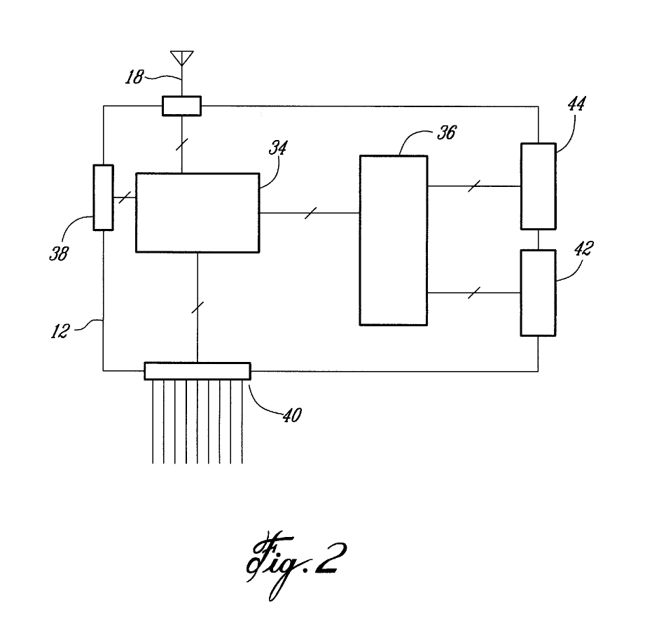

Referring now to FIG. 2 in addition to FIG. 1, the interface 12 comprises a programmable electronic component, such as a microprocessor 34 (or a microcontroller), connected to control circuitry as in 36. The interface 12 illustratively further comprises a data port 38 and/or analog inputs 40, which connect to the microprocessor 34, as well as an input connector 42 and an output connector 44. As will be apparent to a person skilled in the art, the control circuitry 36 may comprise analog and/or digital components depending on the type of vehicle 14 to which the interface 12 is connected and on the desired use of the latter.

Still referring to FIG. 2 in addition to FIG. 1, the microprocessor 34 is illustratively used to manage the logic of the functions of the interface 12, which, in order to start (or stop) the vehicle 14 from a distance, emulates signals of the electronic barrel 24 and/or the pushbutton 30 (as will be described in further detail herein below). In particular, the interface 12, which is added to the installation of the command unit 16 and is controlled by the latter, executes the starting (or stopping) sequence of the vehicle 14 in recreating the analog and/or digital signals that the electronic barrel 24 typically transmits to the vehicle 14 in order to start (or stop) the latter upon insertion of a device as in 26 therein. The microprocessor 34 can illustratively be activated by the antenna 18, the data port 38, the analog inputs 40, the control circuitry 36, or a combination thereof. The activation mode typically depends on the application and on the type of vehicle 14 for which the interface 12 is designed.

Still referring to FIG. 2 in addition to FIG. 1, the control circuitry 36 is used to interface the microprocessor 34 with the wiring harness 32 of the vehicle 14 and/or the interface harness 28. In particular, in order to start or stop the vehicle 14, the control circuitry 36 transmits analog and/or digital signals to the electronic barrel 24 and/or the vehicle 14 via the input connector 42 and/or the output connector 44, respectively. Illustratively, the input connector 42 allows the interface harness 28 to be connected to the electronic barrel 24. It could further allow for additional wires, such as vehicle ignition and the like (not shown), to connect to the interface 12. Similarly, the output connector 44 connects the wiring harness 32 of the vehicle 14 to the interface 12 and could allow for additional wires, such as brake pedal and the like (not shown), to connect to the vehicle 14.

Still referring to FIG. 2 in addition to FIG. 1, both the data port 38 and the analog inputs 40 are used to enable communication between the command unit 16 and the interface 12. According to the technology of the remote control device 20, it may be preferable to use one versus another. In particular, the data port 38 simplifies the installation of the interface 12 on the vehicle 14 by linking the command unit 16 to the interface 12 via a standard cable (not shown). The microprocessor 30 then illustratively uses the communication protocol (conventional protocol or custom data link protocol) of the data port 38 to receive and/or transmit commands. The analog inputs 40, which are illustratively designed to be adapted to the type of microprocessor 34 and the type of vehicle as in 14, typically require more wiring than the data port 38 and may be activated by a variety of commands (e.g. 0, 5 or 12 volts).

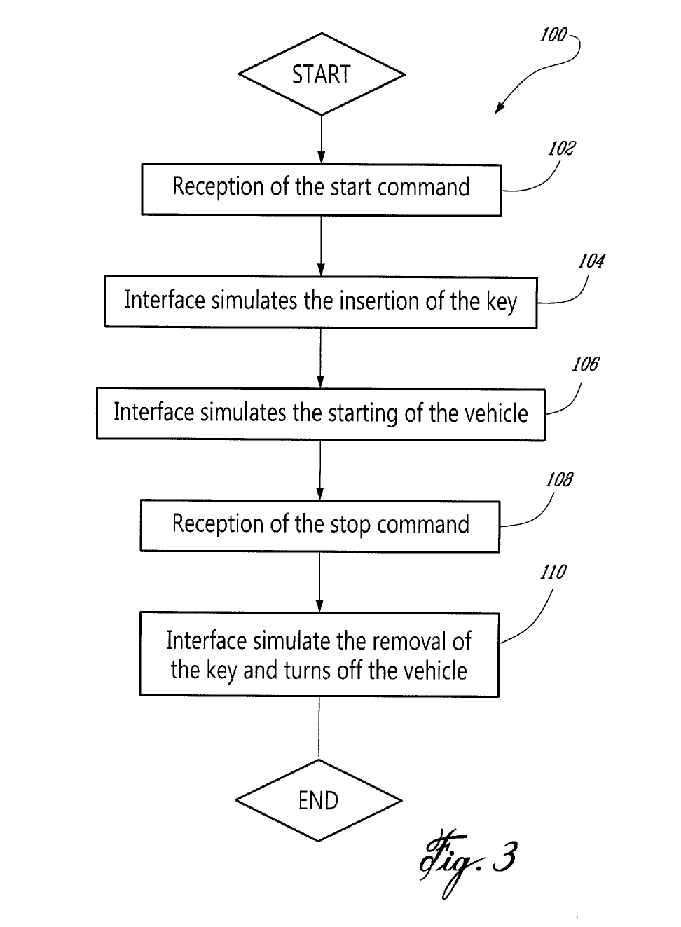

Referring now to FIG. 3 in addition to FIG. 1, a flowchart 100 summarizes the starting (and stopping) sequence of the interface 12. In order to start the vehicle 14, the user initiates a command by actuating the remote control 20, which illustratively sends a radio frequency signal received by the command unit 16 through the antenna 18. The signal is then demodulated by the command unit 16, which subsequently takes decisions relative to secondary modules such as the interface 12 according to the command received. In particular, upon receiving a start command, the command unit 16 sends an authorization to the interface 12 to start the vehicle 14. Upon receiving this command at step 102, the interface 12 simulates insertion of a device as in 26 into the electronic barrel 24 at step 104 and simulates starting of the vehicle 14 at step 106. As known in the art, a vehicle as in 14 equipped with an electronic starting system as in 22 is typically started by the mechanical and/or electrical action resulting from insertion of the device 26 into the electronic barrel 24 (or from activation of the pushbutton 30). In order to start the vehicle 14 remotely, the interface 12 thus reproduces commands that the electronic barrel 24 typically transmits to the vehicle 14 when a device as in 26 is inserted therein and when the vehicle 14 is ignited. As will be apparent to a person skilled in the art, the commands may be analog and/or digital, depending on the vehicle design chosen by the automobile manufacturer. For vehicles as in 14 comprising a pushbutton as in 30, it is for example desirable for the interface 12 to simulate the pressure exerted on the brakes (not shown) of the vehicle 14 when simulating activation of the pushbutton 30. Indeed, as known in the art, pushbutton keyless start allows users to start a vehicle as in 14 by simply depressing the brake pedal and pushing a button on the control panel.

Still referring to FIG. 3 in addition to FIG. 1, upon following the above-mentioned starting sequence 100, the interface 12 is thus capable of remotely starting a vehicle as in 14 having an electronic starting system as in 22. Once the vehicle 14 is started from a distance, the user can then subsequently drive it and travel upon insertion of the device 26 into the electronic barrel 24. It will be apparent to a person skilled in the art that, upon further actuation of the remote control 20, the system 10 allows the user to advantageously maintain the vehicle 14 (especially the engine) switched on without requiring the device 26 to remain present in the electronic barrel for example. For this purpose, the user would actuate the remote control 20 and send a start command to the vehicle 14 prior to removing the device 26 (i.e. the key to the vehicle 14) from the electronic barrel 24. As a result, the vehicle 14 remains switched on and the user can advantageously momentarily step out of the vehicle 14 without having to leave the device 26 therein in order to ensure that the vehicle 14 remains switched on (as would be required without implementation of the system 10).

Still referring to FIG. 3 in addition to FIG. 1, a user wishing to stop the vehicle 14 will actuate the remote control 20, thus initiating a stop command, which is sent to the command unit 16. The command is then transmitted to the interface 12, which illustratively receives it at step 108. Upon reception of this stop command, the interface 12 checks for the presence of a device as in 26 in the electronic barrel 24 in order to simulate its extraction from the electronic barrel 24 at step 110 and subsequently stop the vehicle 14. Depending on whether the device 26 is present in the electronic barrel 24 or not, the interface 12 decides whether or not to shut off the vehicle 14. Typically, if a device 26 is detected in the electronic barrel 24, it is preferable not to stop the vehicle 14 and in this case, the interface 12 does not reproduce signals, which would recreate the vehicle's stopping sequence.

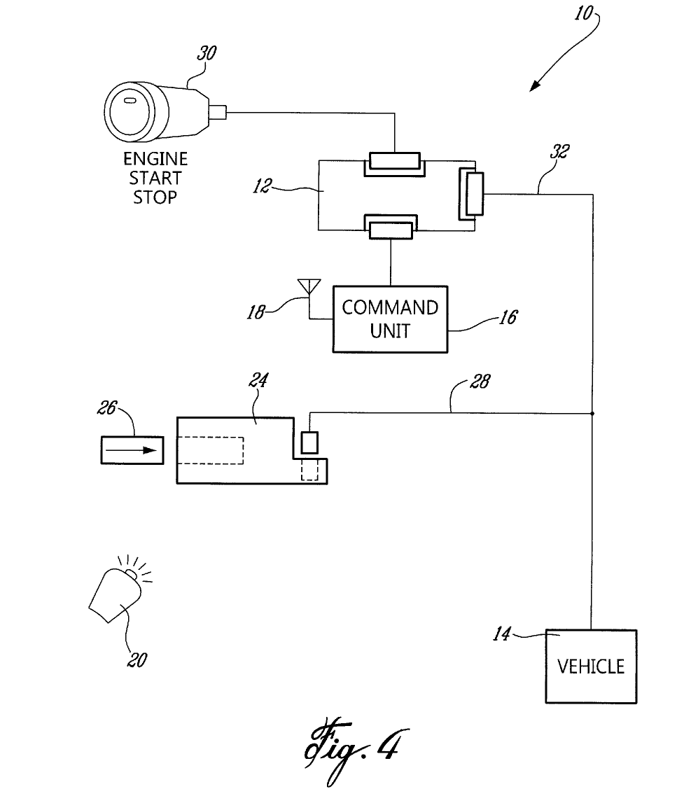

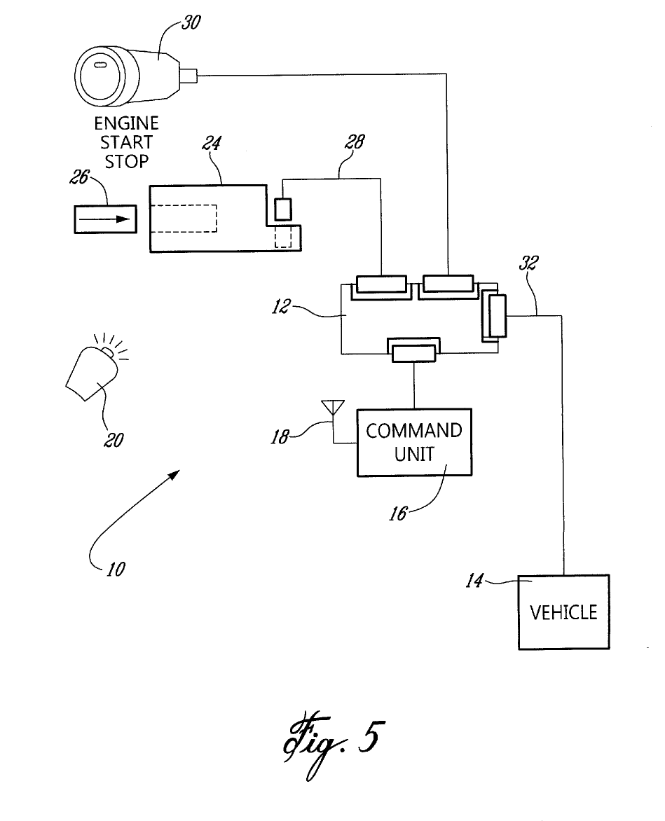

Referring now to FIGS. 4 and 5 in addition to FIG. 1, and as will be apparent to a person skilled in the art, in alternative embodiments of the present invention, the interface 12 can illustratively be installed either in series or in parallel with components of the system 10. In FIG. 1, the interface 12 is installed in series with the electronic barrel 24 while the pushbutton 30 is in parallel with both the interface 12 and the vehicle 14. In FIG. 4 for example, the interface 12 is instead installed in series with the pushbutton 30 while the electronic barrel 24 is in parallel with both the interface 12 and the vehicle 14. Alternatively and as shown in FIG. 5, the interface 12 can be installed in series with both the electronic barrel 24 and the pushbutton 30. Also, according to alternative embodiments of the present invention, the command unit 16 can be either external or internal to the interface 12. In addition, as will be apparent to a person of skill in the art, the system and method of the present invention as described herein above can differ from one vehicle to another.

Although the present invention has been described hereinabove by way of specific embodiments thereof, it can be modified, without departing from the spirit and nature of the subject invention as defined in the appended claims.

We claim:

1. A system for emulating the remote starting and stopping of a vehicle, the system comprising:
an electronic starting system comprising an ignition switch;
an interface installed on the vehicle;
a control unit for commanding said interface; and
a remote control device for transmitting to said control unit start or stop commands to be executed in the vehicle upon actuation by a user,
wherein upon receiving one of said start or stop command, said control unit instructs said interface to emulate electronic signals of said electronic starting system for starting or stopping the vehicle.

2. The system of claim 1, wherein said interface is installed on the vehicle through a wiring harness.

3. The system of claim 2, wherein said interface connects with said wiring harness in series.

4. The system of claim 2, wherein said interface connects with said wiring harness in parallel.

5. The system of claim 1, wherein said control unit is internal to said interface.

6. The system of claim 1, wherein said control unit is external to said interface.

7. The system of claim 1, wherein said ignition switch comprises an electronic barrel and a device adapted to be introduced therein for actuating said ignition switch.

8. The system of claim 7, wherein said device comprises an advanced key system.

9. The system of claim 7, wherein said ignition switch further comprises a push button.

10. The system of claim 7, wherein upon receiving said stop command, prior to instructing said interface to emulate electronic signals of said electronic starting system for starting or stopping the vehicle, said control unit checks for the presence of said device in said electronic barrel.

11. The system of claim 1, wherein said control unit further comprises an antenna for receiving said commands.

12. The system of claim 1, wherein said interface comprises a microprocessor for managing the logic of functions thereof.

13. The system of claim 1, wherein said interface comprises control circuit for transmitting said electronic signals to the vehicle.

14. A method for starting and stopping a vehicle remotely using a system comprising an electronic starting system comprising an ignition switch, a remote control device, a control unit and an interface, the method comprising the steps of:
actuating the remote control device to transmit to the control unit start or stop commands to be executed in the vehicle;
receiving one of said start or stop command at the control unit;
instructing the interface to emulate electronic signals for starting or stopping the vehicle.

15. The method of claim 14, wherein said interface is installed on the vehicle through a wiring harness.

16. The method of claim 15, wherein said interface connects with said wiring harness in series.

17. The method of claim 15, wherein said interface connects with said wiring harness in parallel.

18. The method of claim 14, wherein said control unit is internal to said interface.

19. The method of claim 14, wherein said control unit is external to said interface.

20. The method of claim 14, wherein said ignition switch comprises an electronic barrel and a device adapted to be introduced therein for actuating said ignition switch.

21. The method of claim 20, wherein said device comprises an advanced key system.

22. The method of claim 20, wherein said ignition switch further comprises a push button.

23. The method of claim 20, wherein upon receiving said stop command, prior to instructing said interface to emulate electronic signals of said electronic starting system for starting or stopping the vehicle, said control unit checks for the presence of said device in said electronic barrel.

24. The method of claim 14, wherein said control unit further comprises an antenna for receiving said commands.

25. The method of claim 14, wherein said interface comprises a microprocessor for managing the logic of functions thereof.

26. The method of claim 14, wherein said interface comprises control circuit for transmitting said electronic signals to the vehicle.
